(19) United States
(12) Patent Application Publication
(10) Pub. No.: US 2010/0164442 A1
(43) Pub. Date: Jul. 1, 2010

(54) DYNAMIC ADJUSTMENT OF POWER CONVERTER CONTROL

(76) Inventors: Omer Vikinski, Haifa (IL); Jae-Hong Hahn, Beaverton, OR (US); Kobi Littman, Haifa (IL)

Correspondence Address: Ryder, Lu, Mazzeo and Konieczny, LLC;C/O CPA Global, P. O. BOX 52050, MINNEAPOLIS, MN, 55402, US

(21) Appl. No.: 12/347,780

(22) Filed: Dec. 31, 2008

(51) Int. Cl. G05F 1/10

(52) U.S. Cl. 323/234

(57) ABSTRACT

In general, in one aspect, the disclosure describes a system comprising a power converter, a power delivery network, a load, and a communication link between the power converter and the load. The communication link is to implement a training sequence to dynamically adjust parameters of the power converter and set load-line slope based on implementation of the system. The load includes a training capability to generate stimuli having defined patterns and to update on the stimuli application to the power converter over the communication link. The power converter includes a controller to measure noise amplitude in a power output based on the stimuli, to adjust loop parameters to reduce the noise amplitude, and to set the load-line for the power converter based on the adjusting.

### BACKGROUND

Power converters are utilized to convert power from one domain to another and provide the converted power to a load. The behavior of the power converter may be affected by multiple factors within the system with which it serves. Design constraints include input and output voltage levels, load range and dynamics and output voltage performance targets. The main sources of design variation in this context are passive components such as inductors and capacitors values, precision, reliability and finally the actual number of attached passive parts and their locations, based on the board area and bill of material optimization. The use of a power converter with a particular load within a system may require the converter compensation parameters to be modified (possibly by modifying the delivery network) or to tolerate the performance of the power converter in the system design.

### BRIEF DESCRIPTION OF THE DRAWINGS

The features and advantages of the various embodiments will become apparent from the following detailed description in which:

FIG. 1 illustrates a high level block diagram of a power supply system;

FIG. 2 illustrates a block diagram of a power supply system providing dynamic power conversion tuning, according to one embodiment;

FIG. 3 illustrates a timing diagram of an example implementation of a controller training capability (CTC) procedure, according to one embodiment; and

FIG. 4 illustrates example improvement in impedance profile of the output voltage of the power converter over the frequency domain, according to one embodiment.

### DETAILED DESCRIPTION

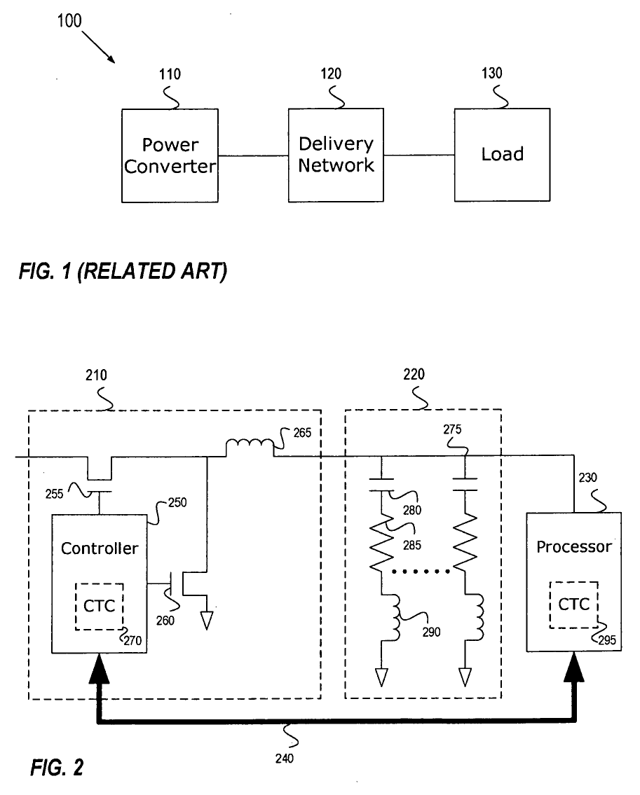

FIG. 1 illustrates a high level block diagram of a power supply system 100. The system 100 includes a power convertor 110, a delivery network 120 and a load (processor) 130. The power converter 110 converts a first power domain (e.g., platform power) to a second power domain required by the load 130 and regulates the second power domain. The delivery network 120 delivers the second power domain to the load 130. The load 130 performs processing for the platform 100. The interaction between the power converter 110, the delivery network 120 and the load 130 may affect the efficiency and performance of both the power converter 110 and the load 130. The efficiency and performance of the power converter 110 may affect the performance, reliability and consumed power of the system 100.

FIG. 2 illustrates a block diagram of a power supply system 200 providing dynamic power conversion tuning. The system 200 includes a power convertor 210, a delivery network 220, a load (processor) 230, and a bidirectional interface 240. The bidirectional interface 240 provides a communication link between the between the load 230 and the power converter 210. The power converter 210 may include a controller 250, power circuitry (e.g., high side transistors 255, low side transistors 260, inductors 265) and a communications interface (not illustrated) to connect to the communication link 240. The controller 250 includes a controller training capability (CTC) 270. The power delivery network 220 may include decoupling paths 275 that may include capacitors 280, parasitic resistive paths 285 and parasitic inductive paths 290. The load 230 may include functional circuitry (not illustrated), a CTC 295 and a communications interface (not illustrated) to connect to the communication link 240. The load CTC 295 and the controller CTC 270 may communicate there between in order to dynamically adjust the power convertor 210 parameters to improve performance and efficiency based on the environment the power converter 210 is being used in and the state and dynamic requirements of the load 230. An interface protocol may be defined to enable the communications between the load CTC 295 and the controller CTC 270.

The load CTC 295 may produce stimuli at a defined pattern and provide the stimuli to the controller 250 (via the communications link 240). The stimuli at the defined pattern may represent load application and defined dynamic changes thereto (e.g., load toggling). The stimuli may be applied at a defined frequency. The stimuli may create noise in the power (voltage) output from the power converter 210 at the defined frequency. The voltage noise amplitude is then measured and reported thought the communication link 240, and the controller 250 loop parameters are adjusted in order to reduce the noise (e.g., reduce the magnitude of the voltage oscillations). The controller 250 may provide the noise measurements to the load 230 since most of the infrastructure for voltage sampling and processing is already contained therein. After the controller 250 has adjusted its loop parameters and thus the converter 210 behavior, the controller 250 may inform the load 230 and the load CTC 295 may again provide the stimuli to the controller 250. The mutual interaction between the load CTC 295 and the controller 250 may continue in order to optimize the voltage noise amplitude. After it determined that the adjustments are satisfactory (e.g., the noise generated is tolerable, the noise is as low as possible under the specific conditions), the adjustment (converter loop parameters) may be recorded in the controller CTC 270.

The load CTC 295 may then produce different stimuli at a next defined pattern and provide the stimuli to the controller 250. The controller 250 and the load CTC 295 may mutually interact in order to optimize the voltage noise amplitude and to provide the controller 250 with the required loop parameters.

The specific set of patterns that the stimuli are generated for may be configured (e.g., by firmware). Periodic patterns at given frequency points may be selected to represent the location of susceptibility to power delivery resonances or converter 210 related mismatches. For example, a frequency in the range of 1-10 KHz may be selected for tuning device mismatches (e.g., DCR sense filter mismatch) and a frequency of between 100-400 KHz may be selected for resonances (e.g., output capacitors deprivation) of the power delivery network 220.

The CTC procedure described above may be initiated by the load 230 at specific instances (e.g., initial use, reset, crash). The load 230 may halt its operation in order to initiate the CTC procedure. For example, upon initial use of the load 230 once the power ramp of the load 230 is complete and voltage level is set the CTC initiation may occur. As part of the CTC procedure, the load-line (e.g., voltage positioning slope) of the power converter 210 can be set based on the dynamic optimization and adjustments that were made and are stored in the controller CTC 270 (the training of the converter 210 for the specific platform).

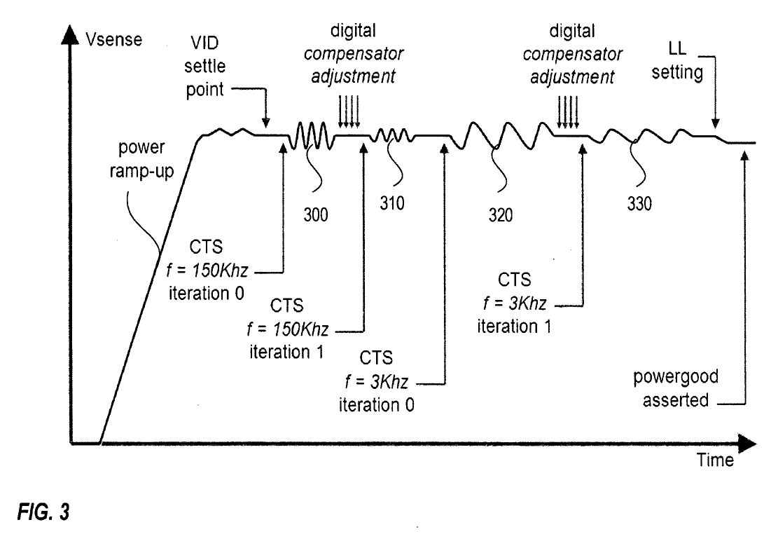

FIG. 3 illustrates a timing diagram of an example implementation of a CTC procedure. The power is ramped up and after the associated voltage level of the power converter 210 is achieved (voltage identification (VID) settle point) the CTC procedure is implemented. At this point, the load functions may still be disabled or if they have been activated, they may be halted during implementation of the CTC procedure. The load CTC 295 may initiate a first iteration (e.g., iteration 0) of the stimuli at a first pattern (e.g., 150 KHz repetitive load toggling) which may result in noise (oscillations on output voltage) 300. The controller 250 of the power converter 210 may perform compensation parameter adjustments to reduce the noise. After the controller 250 has made some adjustments, the load CTC 295 may initiate another iteration (e.g., iteration 1) of the first pattern stimuli which may result in noise 310 having a lower amplitude of oscillations then the noise 300 created by the iteration 0.

If the noise is determined to be at an acceptable level for the first stimuli, the load CTC 295 may initiate a first iteration (e.g., iteration 0) of a repetitive stimuli at a second (different from the first) stimuli pattern (e.g., 3 KHz repetitive load toggling) which may result in noise 320. The controller 250 may perform compensation parameter adjustments. The load CTC 295 may then initiate another iteration (e.g., iteration 1) at the second stimuli pattern, which may result in less, noise 330. After the CTC procedure is complete, the voltage positioning slope (DC load line) may be set and the operation of the load 230 can be allowed or returned (e.g., power good is asserted).

The DC load-line may be set based on the parameters learned about the specific platform and the resulting dynamic noise magnitudes that were achieved through the converter training. For example, the converter 210 may have learned the minimal achieved dynamic AC droops that can be affected by the power converter compensation bandwidth (e.g., 3rd droops, possibly 2nd droops). The DC load-line no longer needs to be bound to the worst-case design scenario that can be expected from the load. An improved DC load-line can be used to save energy by lowering the VID without effecting load performance or to increase load performance by raising the VID without affecting reliability. These improvements are based on the reduced voltage noise window achieved by the CTC procedure.

It should be noted that the timing diagram of FIG. 3 included two iterations for each unique load pattern but it is not limited thereto. Rather, the number of iterations may be based on how many iterations are required to achieve an acceptable noise level or a time budget for the CTC procedure that might serve as upper limit to the flow duration. The acceptable noise level may be determined by the load 230. The acceptable noise level may be configurable. The amount of time that compensator parameter adjustments may be made by the controller 250 before the load CTC 295 resends a stimuli may commonly be bound to avoid indefinite time for the flow. For example, the adjustments may be made for a defined period (fixed or configurable) or based on a determination that the adjustments are complete. The determination of when the adjustments are complete may be made by the power converter 210 or by the load 230. In cases where the flow is being finished because the defined period lapsed (e.g., met or exceeded duration time limit) or the optimization process does not converge, the default initial settings or the best intermediate results may be used. The number of patterns, their spectral content, and waveform shapes provided from the load CTC 295 to the converter 210 are not limited to those illustrated. The number of patterns, their spectral content, and the waveform shapes may be configured by a user (e.g., platform designer).

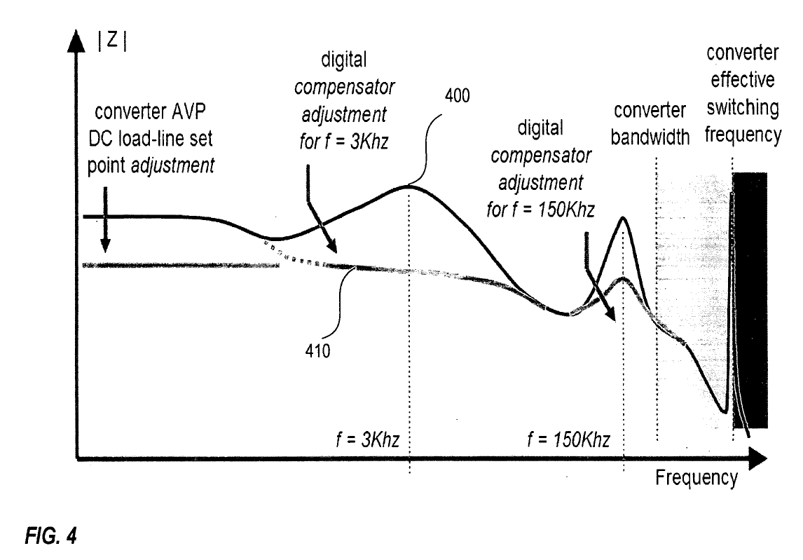

FIG. 4 illustrates example improvement in impedance profile of the power converter 210 output voltage over the frequency domain. An example impedance profile before application of the CTC 400 shows resonance peaks in the impedance profile at the certain frequencies (e.g., 3 KHz, 150 KHz). An example post CTC impedance profile 410 shows that the resonance peaks have been leveled out and that the impedance profile has a relatively flat slope at the frequency range of the converter bandwidth. That is, inside the range of converter bandwidth specific resonances can be optimized by the compensator CTC adjustment iterative process. The frequency regions above the converter bandwidth and surely those above the converter effective switching frequency are not relevant and cannot be affected by the CTC or any of the converter related features.

At the end of the procedure, the DC load-line slope can be set to achieve adjustable voltage positioning (AVP) matching with the converter output filter stage. As illustrated, the DC load line was able to be reduced based on the CTC. It should be noted that the CTC may have a maximum limit for the DC load-line.

Dynamic adjustment of the converter compensation enables reduction of power supply noise, and may enable individualized settling of load-line slope per given implementation. This may enable reduction of VID and increase in efficiency, energy saving, and reliability related degradations.

It should be noted that the disclosure focused on the load 230 providing the stimuli and synchronizing the flow for the CTC process, but is not limited thereto. While a processor load can easily be designed to define the agent creating the stimuli and the interface protocol providing the communications, regular loads may find those requirements too complex to handle. According to one embodiment, the controller 250 may send stimuli signals to an external device (dummy load) that may generate a mimic of load transient changes in given frequency point and specified magnitudes. The controller response could be also optimized for reference voltage transients, generated by the controller during the training period.

Although the disclosure has been illustrated by reference to specific embodiments, it will be apparent that the disclosure is not limited thereto as various changes and modifications may be made thereto without departing from the scope. Reference to “one embodiment” or “an embodiment” means that a particular feature, structure or characteristic described therein is included in at least one embodiment. Thus, the appearances of the phrase “in one embodiment” or “in an embodiment” appearing in various places throughout the specification are not necessarily all referring to the same embodiment.

The various embodiments are intended to be protected broadly within the spirit and scope of the appended claims.

What is claimed:

1. A method comprising
receiving stimuli having defined patterns;
generating a power output based on a power input, loop parameters, and the stimuli;
measuring noise amplitude in the power output;
adjusting loop parameters to reduce the noise amplitude; and
setting a load-line based on the adjusting.

2. The method of claim 1, wherein the receiving includes receiving the stimuli representing load application and defined dynamic changes thereto.

3. The method of claim 2, wherein the measuring includes measuring the noise amplitude in response to the load application and the defined dynamic changes.

4. The method of claim 1, wherein the receiving includes receiving the stimuli at frequency points susceptible to power delivery resonances.

5. The method of claim 1, wherein the receiving includes receiving the stimuli at frequency points susceptible to power converter related mismatches.

6. The method of claim 1, wherein the receiving, the measuring and the adjusting are repeated until the noise amplitude reaches at least one of an acceptable level and an optimal operating point.

7. The method of claim 1, wherein the receiving, the generating, the measuring and the adjusting may be repeated for a plurality of stimuli having different defined patterns.

8. The method of claim 7, wherein the setting includes setting the load-line based on the adjusting for the plurality of stimuli and achieved impedance profile resonance peaks.

9. The method of claim 1, wherein the receiving includes receiving the stimuli from a processor load.

10. A power converter comprising
a controller;
power circuitry; and
a communication interface to communicate with a load to implement a training sequence to dynamically adjust parameters of the power converter and set load-line slope, wherein the parameters are adjusted to account for at least one of: configuration of system the power converter is implemented in, power converter related mismatches, and power delivery resonance points.

11. The power converter of claim 10, wherein the controller is to
receive stimuli having defined patterns from the load,
measure noise amplitude in a power output based on the stimuli,
adjust loop parameters to reduce the noise amplitude, and
set the load-line for the power converter based on the adjusting.

12. The power converter of claim 10, wherein the stimuli represent load application and defined dynamic changes thereto at frequencies that are susceptible to power delivery resonances and power converter related mismatches.

13. The power converter of claim 11, wherein the stimuli is to be user configurable, wherein the user configuration is to include number of patterns, their spectral content, and waveform shapes generated thereby.

14. The power converter of claim 11, wherein the controller is to
track the loop parameters for specific stimuli after the noise measured for the specific stimuli reaches at least one of an acceptable level and an optimal operating point, and
set the load line after the loop parameters are set for each specific stimuli provided by the training capability.

15. The power converter of claim 14, wherein the load is to define an acceptable noise level or default reference point.

16. The power converter of claim 10, wherein the load is a dummy load and the controller is to
provide stimuli to the dummy load in order to have the dummy load generate a mimic of load transient changes in given frequency point and specified magnitude,
measure noise amplitude in a power output based on the stimuli,
adjust loop parameters to reduce the noise amplitude, and
set the load-line for the power converter based on the adjusting.

17. The power converter of claim 10, wherein the controller is to optimize the power converter for reference voltage transients generated by the controller during the training period.

18. An apparatus comprising
functional circuitry;
a training capability to generate stimuli, wherein the stimuli represent load application and defined dynamic changes thereto at frequencies that are susceptible to power delivery resonances and power converter related mismatches;
a communication interface to communicate with a power converter to implement a training sequence to dynamically adjust parameters of the power converter and set load-line slope.

19. The apparatus of claim 18, wherein the training capability is to
define an acceptable noise level or default reference point;
receive noise measurements from the power converter; and
instruct the power converter to set its parameters when the noise measurements reach the acceptable noise level or the default reference point

20. The apparatus of claim 18, wherein the training capability is to be user configurable, wherein a user can have configure the stimuli to define number of patterns, their spectral content, and waveform shapes generated thereby.
